(19) United States
(12) Patent Application Publication
(10) Pub. No.: US 2024/0004962 A1
(43) Pub. Date: Jan. 4, 2024

(54) SYSTEM AND METHOD FOR ANALYZING EVENT DATA OBJECTS IN REAL-TIME IN A COMPUTING ENVIRONMENT

(71) Applicant: Qualetics Data Machines, Inc., Skillman, NJ (US)

(72) Inventor: Sumanth Vakada, Skillman, NJ (US)

(21) Appl. No.: 18/344,958

(22) Filed: Jun. 30, 2023

Related U.S. Application Data
(60) Provisional application No. 63/357,024, filed on Jun. 30, 2022.

(51) Int. Cl. G06F 18/2415; G06F 9/54

(52) U.S. Cl. CPC G06F 18/2415; G06F 9/542

(57) ABSTRACT

System and method for analyzing event data objects in real-time in a computing environment are disclosed. The system receives application data from various endpoints. Unique credentials are assigned to client and sub-client devices for each application, allowing restrictions to be applied to streaming of application data associated with specific identifiers. The received event data objects are stored in a database, following predefined formats, and applying endpoint-specific restrictions. Metadata is assigned to each stored event data object, and corresponding output data is also stored in a database based on assigned metadata. The validity parameters of output data are analyzed using ML techniques and data standardization. By correlating event data objects based on validity parameters, a knowledge graph is generated. Real-time analysis of downstream data is performed based on this weightage, leading to a generation of insights, ML-based insights, and AI-based insights.

### CROSS-REFERENCE TO RELATED APPLICATION(S)

This application claims the priority to incorporate by reference the entire disclosure of U.S. provisional patent application No. 63/357,024, filed on Jun. 30, 2022, titled “system and method for artificial intelligence driven machine learning supported event analysis platform”.

### TECHNICAL FIELD

Embodiments of the present disclosure generally relate to event data objects analytics systems and more particularly relates to a system and a method for analyzing event data objects in real-time in a computing environment using an artificial intelligence (AI) driven machine learning supported event analysis platform.

### BACKGROUND

Generally, organizations rely on a common strategy when implementing artificial Intelligence (AI), which involves providing analyzed results as insights to inform operations of the organizations or developing AI-based features for products of the organizations. In both cases, whenever an analysis is required to solve a specific use case, the organization builds different data collection mechanisms and analytical engines tailored to each particular solution. Further, if the analyzed output aims to inform the organization, the insights generated to attempt to present visualizations and analyzed data in a dashboard-style interface. These insights can be distributed or made accessible to relevant parts of the organization that requires the analyzed data output. Whether the insights serve as key performance indicators (KPIs) or aids for operational decision-making, having access to timely and relevant insights holds significant value. Instead of overwhelming staff with an abundance of insights, the objective is to deliver insights that are pertinent to each internal audience.

Further, functional relevance plays a role in determining the insights individuals should receive. For example, an information technology (IT) team may require access to insights related to the IT function, while the sales team needs insights relevant to sales. There is also a clearance relevance aspect, such that the chief technology officer (CTO) may need IT-related insights across the organization, while an IT manager may require insights on IT-related issues within their specific purview. Similarly, the chief sales officer (CSO) may require insights across the entire sales organization, while sales managers or personnel may only need information about the specific segment, they are responsible for. Furthermore, if the analyzed output aims to incorporate AI-based features into a software product, mobile application, or web application, the organization must integrate various analytical engines back into its product. Similar to delivering relevant insights to internal audiences, the analyzed results from AI features may also be intended solely for individual customers. For instance, if an AI feature reports on a specific customer's utilization, the customer should only receive information regarding their activity, rather than the activity of other customers.

Additionally, regardless of whether the objective of the AI capability is to inform an internal audience or enhance customer-facing solutions, the success rate of deploying AI capabilities and performing all the aforementioned tasks such as ingesting data from diverse environments and formats, analyzing it, applying it to machine learning processes, and presenting the analyzed results to the desired audience remains below ten percentage. One of the prevalent challenges in this context is that different software systems and devices possess distinct internal architectures and data structures. As a result, generated data tends to conform to the structure dictated by each source system's unique data model. However, existing AI and machine learning (ML) systems lack built-in processes and capabilities to assign context to the data collected from activities within the environments. Due to the absence of contextual tagging, ML systems must undergo additional steps to label the data with contextual information, enabling intelligent outcomes. This process can be inefficient to build and, more importantly, maintain, making effective scalability nearly impossible.

Conventionally, the systems do not include support for multi-tenancy. If an organization wishes to apply the same analytics, AI, or ML framework to data received from multiple customers, the data must be isolated, secured, and access to the data and analyzed insights must be properly controlled. This necessitates replicating the entire AI data and analytics environment. Such a level of physical and logical separation and security becomes particularly crucial in industries such as healthcare and financial services, where regulatory requirements demand data privacy and security. Furthermore, existing AI systems are implemented within closed environments, posing challenges when extracting real-time results from closed systems.

Consequently, there is a need for an improved system and method for analyzing event data objects in real-time in a computing environment using an artificial intelligence (AI) driven machine learning supported event analysis platform to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for analyzing event data objects in real-time in a computing environment. The system receives application data from one or more endpoints. The one or more endpoints include at least one of a plurality of applications, a plurality of client devices, and a plurality of sub-client devices. Further, the system classifies the received application data into a plurality of categories based on a type of the application data. Furthermore, the system assigns a unique credential for each of at least one of the plurality of client devices and the plurality of sub-client devices corresponding to each of the plurality of applications, based on the classification. Additionally, the system applies one or more restrictions to each of the one or more endpoints for streaming the application data corresponding to a plurality of predefined identifiers, based on assigning the unique credential. Further, the system stores, in a predefined format, a plurality of event data objects received from the one or more endpoints, in a database, based on applying one or more restrictions to each of the one or more endpoints.

Furthermore, the system assigns metadata for each of the stored plurality of event data objects. Additionally, the system stores, in the database, output data corresponding to the plurality of event data objects, based on the assigned metadata. The database is a part of at least one of a multi-tenant data storage, multi-tenant data analytics, and artificial intelligence (AI)-based insights and outcome generation. Further, the system analyzes a plurality of validity parameters of the output data, using at least one of a machine learning (ML) technique, and applying data standardization technique for the analyzed plurality of validity parameters.

Further, the system generates a knowledge graph corresponding to the plurality of event data objects, by correlating the plurality of event data objects, based on the analyzed plurality of validity parameters of the output data. Additionally, the system extracts a dependency map from the generated knowledge graph for identifying standard workflows and standard sequences within each of the one or more endpoints. Further, the system classifies the plurality of validity parameters based on at least one of an occurrence frequency and one or more connections in the generated knowledge graph, based on the extracted dependency map. Furthermore, the system assigns a weightage to the plurality of validity parameters, based on the classification of the plurality of validity parameters. Additionally, the system analyzes downstream data corresponding to the plurality of event data objects in real time, based on the assigned weightage. Further, the system generates one or more insights, in real-time, based on the analyzed downstream data. Furthermore, the system generates, in real-time, one or more machine learning (ML)-based insights, one or more AI-based insights, based on ML-based analytics of the generated one or more insights and the analyzed downstream data. The one or more machine learning (ML)-based insights generated in real-time comprises at least one of exceptions occurring during event analysis, transactions, activities on websites, applications, and social media posts.

Another aspect of the present disclosure provides a method for analyzing event data objects in real-time in a computing environment. The method includes receiving application data from one or more endpoints. The one or more endpoints comprise at least one of a plurality of applications, a plurality of client devices, and a plurality of sub-client devices. Further, the method includes classifying the received application data into a plurality of categories based on a type of the application data. Furthermore, the method includes assigning a unique credential for each of at least one of the plurality of client devices and the plurality of sub-client devices corresponding to each of the plurality of applications, based on the classification. Additionally, the method includes applying one or more restrictions to each of the one or more endpoints for streaming the application data corresponding to a plurality of predefined identifiers, based on assigning the unique credential. Further, the method includes storing in a predefined format, a plurality of event data objects received from the one or more endpoints, in a database, based on applying one or more restrictions to each of the one or more endpoints. Furthermore, the method includes assigning metadata for each of the stored plurality of event data objects. Further, the method includes storing, in the database, output data corresponding to the plurality of event data objects, based on the assigned metadata. The database is a part of at least one of a multi-tenant data storage, multi-tenant data analytics, and artificial intelligence (AI)-based insights and outcome generation.

Furthermore, the method includes analyzing a plurality of validity parameters of the output data, using at least one of a machine learning (ML) technique, and applying data standardization technique for the analyzed plurality of validity parameters. Additionally, the method includes generating a knowledge graph corresponding to the plurality of event data objects, by correlating the plurality of event data objects, based on the analyzed plurality of validity parameters of the output data. Further, the method includes extracting a dependency map from the generated knowledge graph for identifying standard workflows and standard sequences within each of the one or more endpoints. Furthermore, the method includes classifying the plurality of validity parameters based on at least one of an occurrence frequency and one or more connections in the generated knowledge graph, based on the extracted dependency map. Additionally, the method includes assigning a weightage to the plurality of validity parameters, based on the classification of the plurality of validity parameters. Further, the method includes analyzing downstream data corresponding to the plurality of event data objects in real time, based on the assigned weightage. Furthermore, the method includes generating one or more insights, in real-time, based on the analyzed downstream data. Further, the method includes generating, in real-time, one or more machine learning (ML)-based insights, one or more AI-based insights, based on ML-based analytics of the generated one or more insights and the analyzed downstream data. The one or more machine learning (ML)-based insights generated in real-time comprises at least one of exceptions occurring during event analysis, transactions, activities on websites, applications, and social media posts.

Yet another aspect of the present disclosure provides a non-transitory computer-readable storage medium having programmable instructions stored therein. That when executed by one or more hardware processors cause the one or more hardware processors to receive application data from one or more endpoints. The one or more endpoints comprise at least one of a plurality of applications, a plurality of client devices, and a plurality of sub-client devices. Further, the one or more hardware processors classify the received application data into a plurality of categories based on a type of the application data. Furthermore, the one or more hardware processors assign a unique credential for each of at least one of the plurality of client devices and the plurality of sub-client devices corresponding to each of the plurality of applications, based on the classification. Additionally, the one or more hardware processors apply one or more restrictions to each of the one or more endpoints for streaming the application data corresponding to a plurality of predefined identifiers, based on assigning the unique credential. Further, the one or more hardware processors store, in a predefined format, a plurality of event data objects received from the one or more endpoints, in a database, based on applying one or more restrictions to each of the one or more endpoints. Furthermore, the one or more hardware processors assign metadata for each of the stored plurality of event data objects. Additionally, the one or more hardware processors store, in the database, output data corresponding to the plurality of event data objects, based on the assigned metadata. The database is a part of at least one of a multi-tenant data storage, multi-tenant data analytics, and artificial intelligence (AI)-based insights and outcome generation. Furthermore, the one or more hardware processors analyze a plurality of validity parameters of the output data, using at least one of a machine learning (ML) technique, and applying data standardization technique for the analyzed plurality of validity parameters.

Furthermore, the one or more hardware processors generate a knowledge graph corresponding to the plurality of event data objects, by correlating the plurality of event data objects, based on the analyzed plurality of validity parameters of the output data. Further, the one or more hardware processors extract a dependency map from the generated knowledge graph for identifying standard workflows and standard sequences within each of the one or more endpoints. Additionally, the one or more hardware processors classify the plurality of validity parameters based on at least one of an occurrence frequency and one or more connections in the generated knowledge graph, based on the extracted dependency map. Further, the one or more hardware processors assign a weightage to the plurality of validity parameters, based on the classification of the plurality of validity parameters. Furthermore, the one or more hardware processors analyze downstream data corresponding to the plurality of event data objects in real time, based on the assigned weightage. Additionally, the one or more hardware processors generate one or more insights, in real-time, based on the analyzed downstream data. Furthermore, the one or more hardware processors generate, in real-time, one or more machine learning (ML)-based insights, one or more AI-based insights, based on ML-based analytics of the generated one or more insights and the analyzed downstream data. The one or more machine learning (ML)-based insights generated in real-time comprises at least one of exceptions occurring during event analysis, transactions, activities on websites, applications, and social media posts.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a network architecture implementing a system for analyzing event data objects in real-time in a computing environment, in accordance with an embodiment of the present disclosure;

FIG. 2 illustrates an exemplary block diagram representation of a computer-implemented system, such as those shown in FIG. 1, capable of analyzing event data objects in real-time in a computing environment, in accordance with an embodiment of the present disclosure;

FIG. 3 illustrates an exemplary block diagram representation of an overview of an event analysis platform, in accordance with an embodiment of the present disclosure;

FIG. 4 illustrates a flow chart depicting an event analysis method, in accordance with an embodiment of the present disclosure;

FIG. 5 illustrates a flow chart depicting a method of analyzing event data objects in real-time in a computing environment, in accordance with the embodiment of the present disclosure; and

FIG. 6 illustrates an exemplary block diagram representation of a hardware platform for implementation of the disclosed system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure provide a system and a method for analyzing event data objects in real-time in a computing environment. The present disclosure provides a platform for event analysis supported by artificial intelligence (AI) and machine learning (ML) techniques. The platform utilizes AI-driven machine-learning techniques to analyze events generated during digital experiences. The events encompass various actions, such as a user clicking a button in an interface or an IoT device recording data such as mechanical readings or geolocation information. The platform ingests the data in real-time and leverages AI-driven machine learning algorithms to derive insights. The present disclosure provides interfaces and processes for web applications, mobile applications, internal software, and internet of things (IoT) systems to stream data with contextual information (describing what and/or where the event occurs), actor information (identifying who or what initiates the event), action details (describing the action taking place in the event), and object information (identifying the entity subject to the action and context, such as a product, person, or location). These inputs enable the platform to process data and generate real-time insights. The insights can be delivered either through the platform's graphical user interface or via representational state transfer (REST) application programming interface (API) connections to the customer's software products as AI features. The AI-driven machine learning-supported event analysis platform comprises key processes such as data ingestion, data analysis, insight generation, insight delivery, and more. The sender, in this context, refers to users, clients, and similar entities.

Further, the present disclosure incorporates intelligent decision frameworks based on machine learning to enhance software applications using the data generated by these applications. Additionally, the present disclosure extends intelligent decision frameworks to sensor-driven devices, leveraging machine learning on data generated by IoT sensors, and to software processes, using machine learning on data generated by automated software routines. This automation enables the identification of anomalies and severity in user flow interactions, providing insights into previously challenging defects in user experience. The present disclosure also facilitates the identification of process flow issues and severity, shedding light on difficult process gaps in automated software routines. Furthermore, the present disclosure enables the identification and assessment of anomalies and severity in IoT data events streamed from sensors embedded in physical devices.

Furthermore, the present disclosure encompasses the application of self-corrective mechanisms for software applications based on event intelligence generated from real-time data gathering, processing, and analysis. The present disclosure provides a visual interface for IoT data and facilitates integration with other systems, offering real-time insights for businesses to address customer issues. The present disclosure may include data standardization. The event analysis platform of the present disclosure enables systems to stream data in a standardized format, allowing for uniformity in the captured data from different systems. The present disclosure eliminates the need for manual setup for each new customer, as all steps are automatically enabled once the setup is initiated, requiring no human intervention. Standardizing the data before analysis is a crucial step that accelerates the generation of real-time insights compared to other systems where bespoke mechanisms are required for each new set of data points. Contextual capturing of data is another advantage of the present disclosure. The event analysis platform of the present disclosure captures information contextually and transforms it into a standardized format. This auto-labeling of data in real-time enables real-time data processing and enhances historical analysis with improved accuracy and actionable insights.

The present disclosure also offers multi-system support. The present disclosure integrates multiple processes into a single solution, simplifying the extraction and integration of insights from data collected at source systems, and eliminating the need for intermediate systems like crawlers or data feeds. The present disclosure provides a multi-tenant design, particularly suitable for business-to-business (B2B) software-as-a-service (SaaS) service providers. The present disclosure incorporates a multi-tenant design, ensuring that data gathered from different customers are stored in separate tenant instances, with provisions for sub-tenants to store their data. The present disclosure enables auto scalability for handling extremely high volumes of real-time data gathering, as opposed to other solutions that only present metadata results for high-volume data activity by indexing data in real-time.

The event analysis platform of the present disclosure empowers businesses with self-learning, self-monitoring, self-healing, and adaptive process implementation capabilities for software applications, information technology (IT) and non-IT systems, automated and semi-automated processes, industrial machinery, automotive systems, healthcare devices, and all other connected systems. This is achieved by utilizing contextual event data generated by web applications, mobile applications, software systems, sensors, and devices. AI systems often incorporate machine learning (ML) capabilities, which improve the accuracy of their analyzed results as they process and analyze more data, resulting in the AI-driven ML-supported event analysis platform. Furthermore, the event analysis platform of the present disclosure efficiently distributes the analyzed AI output to specific audiences or integrates it with customer-facing solutions, leveraging AI to enhance the customer experience and the value of the solutions. The present disclosure supports the entire process from data ingestion through analysis to insight delivery, incorporating multi-tenant and user permission controls, as well as insight delivery, output, and socializing features, all within a single scalable platform.

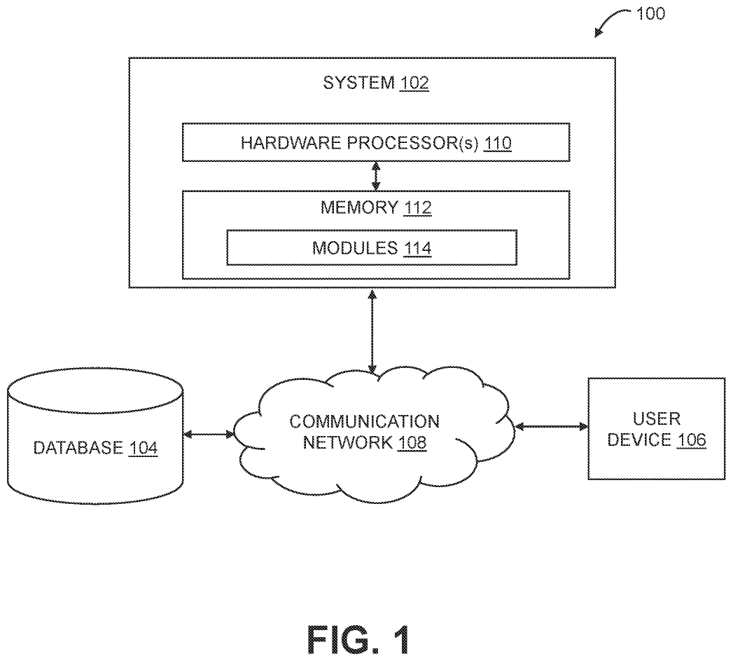

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 illustrates an exemplary block diagram representation of a network architecture implementing a system for analyzing event data objects in real-time in a computing environment, in accordance with an embodiment of the present disclosure. According to FIG. 1, the network architecture 100 may include the system 102, a database 104, and a user device 106. The system 102 may be communicatively coupled to the database 104, and the user device 106 via a communication network 108. The communication network 108 may be a wired communication network and/or a wireless communication network. The database 104 may include, but is not limited to, application data, type of the application data, event data objects, metadata, output data corresponding to the plurality of event data objects, multi-tenant data, standardized data, validity parameters, downstream data, software application data, web application data, mobile application data, and Internet of Things (IoT) sensor-enabled devices data, any other data, and combinations thereof. The database 104 may be any kind of database such as, but are not limited to, relational databases, dedicated databases, dynamic databases, monetized databases, scalable databases, cloud databases, distributed databases, any other databases, and combination thereof.

Further, the user device 106 may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for analyzing event data objects in real-time in a computing environment needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for analyzing event data objects in real-time in a computing environment. Execution of the machine-readable program instructions by the hardware processor 110 may enable the proposed system 102 to analyze event data objects in real-time in a computing environment. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at different locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive application data from one or more endpoints (not shown in FIG. 1). The one or more endpoints include, but are not limited to, a plurality of applications, a plurality of client devices, a plurality of sub-client devices, and the like. The application data includes, but is not limited to, software application data, web application data, mobile application data, Internet of Things (IoT) sensor-enabled devices data, and the like. The application data may be received based on streaming by client devices using a plurality of coding languages and a message broker technique.

In an exemplary embodiment, the system 102 may classify the received application data into a plurality of categories based on a type of the application data The type of application data may be from different types of application which may include, but are not limited to web applications, mobile applications, server based applications such as web services, background processes, database operations, internet of things (IoT) sensors that can track signals related to motion, pressure, temperature, density, and the like, data related to signals from network infrastructure such as telecommunications. Examples of applications can be from different business domains, customer relationship management (CRM) systems, enterprise resource planning (ERP) systems, electronic health record and electronic medical record (EHR and EMR), learning management systems (LMS), content management systems (CMS), vehicle tracking software, and the like.

In an exemplary embodiment, the system 102 may assign a unique credential for each of at least one of the plurality of client devices and the plurality of sub-client devices corresponding to each of the plurality of applications, based on the classification. The unique credentials may includes, but are not limited to, an automatically generated client ID and assigned client secret to customers based on one or more distinctions. The distinctions include, but are not limited to, client (organization or company who may be the customer), sub-client (customer of the client who may have a dedicated instance of the clients product or solution), application (the product or solution provided by the client to the sub-client or used by the client directly for their business), unique credentials may be required while transmitting the data to data ingestion services.

In an exemplary embodiment, the system 102 may apply one or more restrictions to each of the one or more endpoints for streaming the application data corresponding to a plurality of predefined identifiers, based on assigning the unique credential. The plurality of predefined identifiers includes, but is not limited to, predefined internet protocol (IP) addresses, predefined hostnames, predefined topics of the application data, and the like. For example, the data being transmitted may be restricted based on the incremental conditions. The conditions include, but are not limited to, data can be transmitted by the clients from a specific application hostname such as example1.ABC.com or example 2.ABC.com, data can be transmitted from a specific IPV4 address format (x.x.x.x). For example—100.110.120.130. The data can be transmitted only to the assigned topic for the message broker. A topic may be typically in the format of /version/PrimaryTopic/SubTopic/Attribute1/Attribute2/ . . . /AttributeN. For publish only restriction, data being published to the message broker can only be consumed by the super administrator account. The system 102 generates the insights available to the customers after processing the data received from each customer's dedicated topic.

In an exemplary embodiment, the system 102 may store, in a predefined format, a plurality of event data objects received from the one or more endpoints, in the database 104, based on applying one or more restrictions to each of the one or more endpoints. The predefined format includes, but is not limited to, an actor, an action, a context, objects, and the like.

In an exemplary embodiment, the system 102 may assign metadata for each of the stored plurality of event data objects. The metadata includes, bit is not limited to, a timestamp, a geolocation, device information, and the like.

In an exemplary embodiment, the system 102 may store, in the database 104, output data corresponding to the plurality of event data objects, based on the assigned metadata. The database may be a part of, but is not limited to, multi-tenant data storage, multi-tenant data analytics, artificial intelligence (AI)-based insights and outcome generation, and the like.

In an exemplary embodiment, the system 102 may analyze a plurality of validity parameters of the output data, using at least one of a machine learning (ML) technique, and applying data standardization technique for the analyzed plurality of validity parameters. The plurality of validity parameters includes, but are not limited to, consistency, errors, and a format of an action, an object, a context, an actor, and the like.

In an exemplary embodiment, the system 102 may generate a knowledge graph corresponding to the plurality of event data objects, by correlating the plurality of event data objects, based on the analyzed plurality of validity parameters of the output data. The plurality of event data objects may be correlated based on the metadata and the one or more endpoints to identify relationships between the one or more endpoints. The event data objects include, but are not limited to, actor—the system or entity performing an action related to the event, action (the definition of the action being performed, context (the circumstance or condition under which the action is being performed, object (the object upon which the action is being performed). For example, in the event of a medical diagnosis by a doctor, the following would be classified as the various data objects. The actor may be for example, a doctor performing the diagnosis, action may be medical diagnosis. Similarly, for example, the context may be adverse clinical reaction to drugs, and object may be the patient or subject being diagnosed.

In an exemplary embodiment, the system 102 may extract a dependency map from the generated knowledge graph for identifying standard workflows and standard sequences within each of the one or more endpoints.

In an exemplary embodiment, the system 102 may classify the plurality of validity parameters based on at least one of an occurrence frequency and one or more connections in the generated knowledge graph, based on the extracted dependency map.

In an exemplary embodiment, the system 102 may assign a weightage to the plurality of validity parameters, based on the classification of the plurality of validity parameters. The weightage is assigned based on the combination and frequency of the events, event data objects and attributes related to the event data objects.

In an exemplary embodiment, the system 102 may analyze downstream data corresponding to the plurality of event data objects in real-time, based on the assigned weightage. The downstream data can be data resulting from the analysis of events streamed into the system. Examples of the downstream data are performance analysis of web application events, exception severity rating for event exceptions, engagement scores derived from user activity, clinical diagnosis results based on patient data, student course performance ratings based on student learning activity data, and the like.

In an exemplary embodiment, the system 102 may generate one or more insights, in real-time, based on the analyzed downstream data. The one or more insights include, but are not limited to, descriptive insights, diagnostic insights, predictive insights, and the like.

In an exemplary embodiment, the system 102 may generate, in real-time, one or more machine learning (ML)-based insights, one or more AI-based insights, based on ML-based analytics of the generated one or more insights and the analyzed downstream data. The one or more machine learning (ML)-based insights generated in real-time includes, but are not limited to, exceptions occurring during event analysis, transactions, activities on websites, applications, social media posts, and the like. The ML-based insights include, but are not limited to, a ML-based issue severity detection, a ML-based anomaly detection, a ML-based next best action detection, and the like.

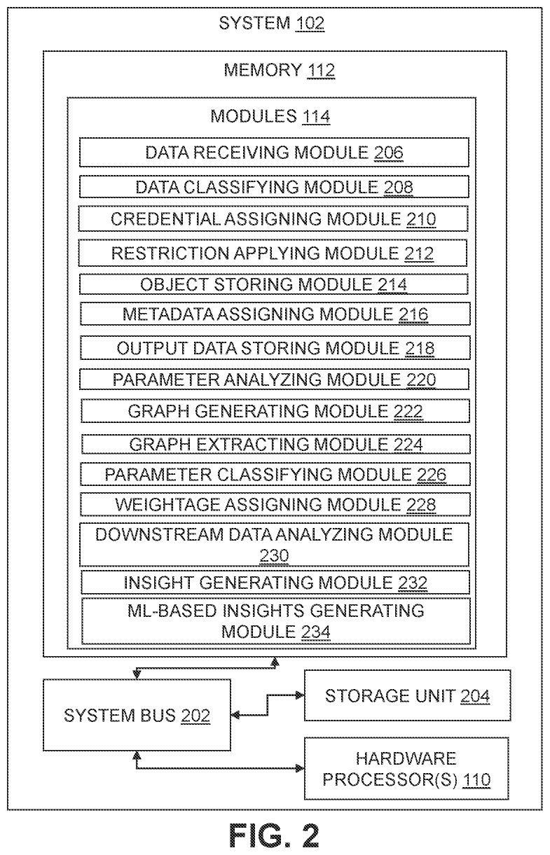

FIG. 2 illustrates an exemplary block diagram representation of a computer-implemented system, such as those shown in FIG. 1, capable of analyzing event data objects in real-time in a computing environment, in accordance with an embodiment of the present disclosure. The system 102 may also function as a computer-implemented system (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

Further, the plurality of modules 114 includes a data receiving module 206, a data classifying module 208, a credential assigning module 210, a restriction applying module 212, an object storing module 214, a metadata assigning module 216, an output data storing module 218, a parameter analyzing module 220, a graph generating module 222, a graph extracting module 224, a parameter classifying module 226, a weightage assigning module 228, a downstream data analyzing module 230, an insight generating module 232, and a ML-based insights generating module 234.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a database such as those shown in FIG. 1. The storage unit 204 may store, but is not limited to, application data, type of the application data, event data objects, metadata, output data corresponding to the plurality of event data objects, multi-tenant data, standardized data, validity parameters, downstream data, software application data, web application data, mobile application data, and Internet of Things (IoT) sensor-enabled devices data, any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the data receiving module 206 may receive application data from one or more endpoints (not shown in FIG. 2). The one or more endpoints include, but are not limited to, a plurality of applications, a plurality of client devices, a plurality of sub-client devices, and the like. The application data includes, but is not limited to, software application data, web application data, mobile application data, Internet of Things (IoT) sensor-enabled devices data, and the like. The application data may be received based on streaming by client devices using a plurality of coding languages and a message broker technique.

In an exemplary embodiment, the data classifying module 208 may classify the received application data into a plurality of categories based on a type of the application data.

In an exemplary embodiment, the credential assigning module 210 may assign a unique credential for each of at least one of the plurality of client devices and the plurality of sub-client devices corresponding to each of the plurality of applications, based on the classification.

In an exemplary embodiment, the restriction applying module 212 may apply one or more restrictions to each of the one or more endpoints for streaming the application data corresponding to a plurality of predefined identifiers, based on assigning the unique credential. The plurality of predefined identifiers includes, but are not limited to, predefined internet protocol (IP) addresses, predefined hostnames, predefined topics of the application data, and the like.

In an exemplary embodiment, the object storing module 214 may store, in a predefined format, a plurality of event data objects received from the one or more endpoints, in the database 104, based on applying one or more restrictions to each of the one or more endpoints. The predefined format includes, but is not limited to, an actor, an action, a context, objects and, the like.

In an exemplary embodiment, the metadata assigning module 216 may assign metadata for each of the stored plurality of event data objects. The metadata includes, bit is not limited to, a timestamp, a geolocation, a device information, and the like.

In an exemplary embodiment, the output data storing module 218 may store, in the database 104, output data corresponding to the plurality of event data objects, based on the assigned metadata. The database may be a part of, but is not limited to, a multi-tenant data storage, multi-tenant data analytics, artificial intelligence (AI)-based insights and outcome generation, and the like.

In an exemplary embodiment, the parameter analyzing module 220 may analyze a plurality of validity parameters of the output data, using at least one of a machine learning (ML) technique, and applying data standardization technique for the analyzed plurality of validity parameters. The plurality of validity parameters includes, but are not limited to, a consistency, errors, and a format of an action, an object, a context, an actor, and the like.

In an exemplary embodiment, the graph generating module 222 may generate a knowledge graph corresponding to the plurality of event data objects, by correlating the plurality of event data objects, based on the analyzed plurality of validity parameters of the output data. The plurality of event data objects may be correlated based on the metadata and the one or more endpoints to identify relationships between the one or more endpoints.

In an exemplary embodiment, the graph extracting module 224 may extract a dependency map from the generated knowledge graph for identifying standard workflows and standard sequences within each of the one or more endpoints.

In an exemplary embodiment, the parameter classifying module 226 may classify the plurality of validity parameters based on at least one of an occurrence frequency and one or more connections in the generated knowledge graph, based on the extracted dependency map.

In an exemplary embodiment, the weightage assigning module 228 may assign a weightage to the plurality of validity parameters, based on the classification of the plurality of validity parameters.

In an exemplary embodiment, the downstream data analyzing module 230 may analyze downstream data corresponding to the plurality of event data objects in real time, based on the assigned weightage.

In an exemplary embodiment, the insight generating module 232 may generate one or more insights, in real-time, based on the analyzed downstream data. The one or more insights include, but are not limited to, descriptive insights, diagnostic insights, predictive insights, and the like.

In an exemplary embodiment, the ML-based insights generating module 234 may generate, in real-time, one or more machine learning (ML)-based insights, one or more AI-based insights, based on ML-based analytics of the generated one or more insights and the analyzed downstream data. The one or more machine learning (ML)-based insights generated in real-time includes, but not limited to, exceptions occurring during event analysis, transactions, activities on websites, applications, social media posts, and the like. The ML-based insights include, but is not limited to, a ML-based issue severity detection, a ML-based anomaly detection, a ML-based next best action detection, and the like.

In an exemplary embodiment, the system 102 may execute an insights retrieving module (not shown in FIG. 2) to retrieve at least one of real-time insights, historic insights, and predictions from the analyzed plurality of validity parameters of the output data corresponding to the event data objects. In an exemplary embodiment, the system 102 may execute an issue severity determining module (not shown in FIG. 2) to determine issue severity using the retrieved at least one of the real-time insights, the historic insights, and the predictions. In an exemplary embodiment, the system 102 may execute a data outputting module (not shown in FIG. 2) to output the retrieved predictions, and the real-time insights to the one or more endpoints in a push-pull format, based on the determined issue severity, and an insights subscription of the one or more endpoints.

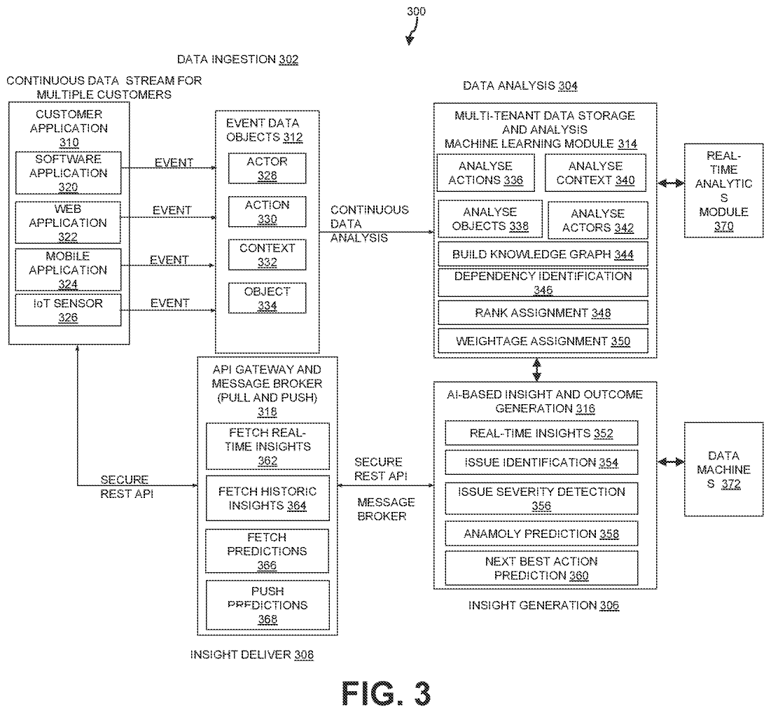

FIG. 3 illustrates an exemplary block diagram representation of an overview of an event analysis platform 300, in accordance with an embodiment of the present disclosure. Throughout the document the Artificial Intelligence (AI) driven machine learning-supported event analysis platform may be referred to as event analysis platform 300. The event analysis platform 300 comprises key processes such as data ingestion 302, data analysis 304, insight generation 306, insight delivery 308, and the like. The system 102 may support a plurality of data such as, but are not limited to, sensor data streamed from Internet of Things (IoT) sensors 326, data from mobile applications 324 which may be a text, image, video, and the like, data from a web application 322, and the like.

In the process of the data ingestion 302, the data is streamed from multiple sources of the data using a proprietary message broker application with a data format designed by the present invention. Further, data streams may be organized by clients, applications, and sub-clients. Further, each client may be assigned a unique set of credentials for each application that they may be streaming the data. Every client is assigned a unique set of credentials such as an application Identity (ID), an application secret ID, and a client ID that may allow the client to stream data for a specific application used by different client instances. Further, additional restrictions may be implemented to limit the clients to stream the data from, but are not limited to, specific internet protocol (IP) addresses, hostnames, specific topics of the data, and the like. Further, the clients may publish data only one way and the clients may not be able to subscribe to other streams of data unless provisioned with a super admin credential that enables them to subscribe to that data. Further, the client streams the data from multiple customer applications 310 such as software applications 320, web applications 322, mobile applications 324, and IoT sensor 326 enabled devices using a wide variety of coding languages. The coding languages may include, but are not limited to, JavaScript®, React®, Angular®, C #®, Python®, React-Native®, and the like. Further, all event data objects 312 may be sent in the format of actor 328, action 330, context 332, and object 334 prescribed by the system 102. Further, a message broker (not shown) assigns metadata for each event data object 312 such as the timestamp, geolocation, and device information. Here, the data may be referred to as a data stream.

In the process of the data analysis 304, the data gathered from the message broker is stored in individual data stores for each client with logically separated data for the sub-clients. Here, multitenant data storage and analysis 314 is performed. Here, an ML model associated with the system 102, analyses an action 336, analyses an object 338, analyses a context 340, and analyses an actor 342 for consistency, errors, and format to ensure that data standardization is applied. By structuring the data into the format of the event data objects 112, all data points are applied to a label at an origin. This data standardization may create a standardized data set for machine learning (ML), where all the data points are labelled with proper definitions. For example, a user data is passed in the actor 328 and such user data is always tagged as data related to people. When the ML model may be trained on this user data, by passing a string value such as Rob or Raj, the ML model may be able to identify that a string is a name belonging to the person. Additional analysis is performed to complete the following steps. At step one, a knowledge graph 344 is built by associating various event data objects 312 such as the actor 328, the action 330 and the context 332, and the object 334 based on timestamp, source system and the client to identify a relationship between each entity. The entity may be a person (also referred to as the actor 328), a product such as a book or a phone (also referred as the object 332), with the action 330 such as a purchase establishing a relationship between the person and the product in the context of a shopping cart. At step two, a dependency map 346 is extracted depending on the knowledge graph 344 to identify common workflows and sequences that are being performed within each individual client system. At step three, each action 330, context 332, and object 334 are assigned ranks 348 after the dependencies are identified based on the frequency of their occurrence and number of connections. At step four, the action 330, the context 332, the actor 328 and the object 334 are assigned a weightage 350 to be utilized while performing additional downstream analysis based on the assigned rank 348.

In the process of the insight generation 306, AI based insights and outcome generation 316 are performed. Various real time insights 352 are generated in the following manner based on data collected and stored in real-time. Firstly, descriptive insights are generated based on user activity and sessions, user action summary, user behavior flow, and clients activity and sessions. The descriptive insights are further generated by touchpoint analytics. This touchpoint analytics comprises steps to complete an outcome, optimal touchpoints, and touchpoint friction analysis. The descriptive insights are further generated by exceptions occurred by the client, by the user, by the action 330, by the context 332, by the object 334, errors or exceptions that occurred per day, device, operating system, and the like. The descriptive insights are further generated by application key performance indicators. Here, the descriptive insights are generated by uptime or downtime of the application, performance lags, and broken flaws. The descriptive insights are further generated by usage anomalies. Here the descriptive insights are generated by unauthorized access attempts, activity anomalies such as repeated login attempts, repeated transactions, multiple logins of the same accounts concurrently from different devices, and multiple logins from different locations concurrently. Secondly, diagnostics insights are generated. The diagnostics insights are generated by the quality index. Here, a qualitative score on the quality of a software system and calculation is based on a total number of issues (which has ten percentage weightage), the severity of issues (which has forty percentage weight) which is dependent on the error ranking algorithm, total users impacted (which has twenty percentage weightage), total modules impacted (which has ten percentage weightage), frequency of the issue occurrence (which has twenty percentage weightage) and the like. The diagnostic insights are further generated by the most frequently occurring errors which are extracted using natural language processing (NLP) based techniques. The diagnostic insights are further generated by the most frequently failing modules. The diagnostic insights are further generated by the most frequently impacted products or applications. Here, diagnostic insights are depicted by a device or an operating system or a browser (here these factors are contributing towards the highest impact). The diagnostic insights are further generated by the most frequently impacted users. Here, the insights are depicted by the device, the browser, or the operating system. The diagnostic insights are further generated by most frequently impacted business to business (B2B) customers. Here, the diagnostic insights are depicted by the device, the browser, or the operating system, correlated between quality index of the application with different descriptive insights and the like. Thirdly, predictive ML-based insights are generated. The ML based insights are generated by ML based issue severity detection 356, ML based anomaly detection 358, ML based next best action detection 360, and the like. By analyzing the workflows, the machine learning model may detect an issue 354 or an anomaly based on behavior that is observed in the past. Any event or sequence of events that deviates from the standard process may be considered as issue 354. The user may be a customer, and the like.

In the process of the insight delivery 308, real-time insights 352 are fetched 362, historic insights 364 are fetched, predictions 366 are fetched and these predictions 366 are pushed 368. The real-time insights 352 generated from the system are available in both push and pull formats where the delivery layer of a system may publish automatically generated insights such as issue severity to any subscribing systems. By implementing an application programming interface (API) gateway and message broker 318 that is connected to an AI system, all results that are derived as part of a Machine Learning process or artificial intelligence model may be available to any internal or external system through the API gateway 318. The internal or external systems may use the API gateway 318 to request information on demand in a secure manner. The message broker 318 becomes useful to queue up requests from external systems that may be served back to a requester in the order they were received. For external systems that subscribe to the message broker 318 to be notified under appropriate conditions, the event analysis platform 300 may push the result to the external system when such conditions are met. For example, if an e-commerce system requests to be notified and if the event analysis platform 300 detects a fraudulent transaction occurring in the e-commerce shopping cart, then the event analysis platform 300 may push a matching result to the e-commerce system when such a condition occurs. Such requests are placed through a message broker subscription. In an embodiment, it is inferred that output of the system 102 may be in different formats such as, but not limited to, a visual format in graphical interfaces or a tabular format, and the like.

Further, the event analysis platform 300 may include real-time analytics module 370. The event analysis platform 300 may analyze data in real time using the real-time analytics module 370 and display the results of the analysis immediately with a sub-second latency in a web portal. The real-time analytics module 370 may analyze distinctly for each individual customer within respective account. The data source for this analysis is the real time events that are ingested using application programming interface (API).

Furthermore, the event analysis platform 300 may include data machines 372 at the back end. The data machines 372 allow users to build automations in a user-friendly graphical user interface (GUI) to combine different artificial intelligence (AI) models to achieve an outcome. Consequently, upon receiving a data input, a data machine may trigger a predefined AI model that may be selected by the user. Further, upon generating a result, the data machine 372 may call another AI model in a sequential order. The output of the preceding model may be the input for the succeeding model. There is no limit to this sequence as long as a valid use case is present. This sequence can also be enhanced with conditional blocks such as an “if-then-else” or a “loop” to execute logic continuously until a condition is satisfied. Once the data machine is created, it can be used on demand using an API request or may also be attached to any event being streamed using an Ingestion API.

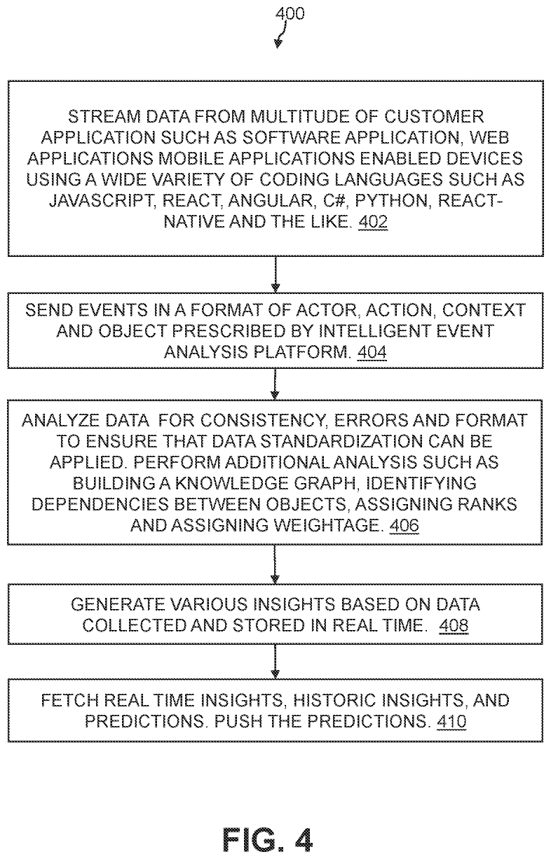

FIG. 4 illustrates a flow chart depicting an event analysis method 400, in accordance with an embodiment of the present disclosure. Examples of various data supported by the present invention are sensor data streamed from Internet of Things (IoT) sensors 326, data from mobile applications 324 which may be a text, image video and the like, data from a web application 322, and the like.

At step 402, the data is streamed by clients, from a multitude of customer applications 310 such as software applications 320, web applications 322, mobile applications 324, IoT sensor 326 enabled devices using a wide variety of coding languages such as JavaScript®, React®, Angular®, C #®, Python®, React-Native®, and the like, using a proprietary message broker application. The data stream may be organized by clients, applications, and sub-clients. Further, each client is assigned a unique set of credentials for each application that they may be streaming that data. Further, additional restrictions may be implemented to limit the client devices stream data from specific internet protocol (IP) addresses, hostnames, or specific topics of data. Further, the clients may publish data only one way and the clients may not be able to subscribe to other streams of the data unless provisioned with a super admin credential that enables them to subscribe to that data.

At step 404, all events data objects 312 (also referred to as data) are sent in the format of actor 328, action 330, context 332, and objects 334 prescribed by the present invention. Metadata is assigned by a message broker for each event data object 312 such as timestamp, geolocation, and device information. The output of step 404 is stored in a database that is part of multi-tenant data storage and analysis 314 and AI-based insights and outcome generation 316.

At step 406, machine learning model analyses an action 336, analyses an object 338, analyses a context 340, and analyses an actor 342 for consistency, errors, and format to ensure that data standardization is applied. Additional analyses are performed by performing the multitenant data storage and analysis 314 and the AI-based insights and outcome generation 316 in the following steps comprising building a knowledge graph 344 by associating the various event data objects 312 such as the actor 328, the action 330, the context 332 and the object 334 based on the timestamp, source system and client to identify the relationship between each entity, extracting a dependency map 346 to identify the common workflows and sequences being performed within each client system, assigning ranks 348 to each action 330, context 332 and object 334 based on the frequency of their occurrence and the number of connections they have to other entities in the knowledge graph 344 and assigning the action 330, the context 332 and the object 334 a weightage 350 to be utilized when performing additional downstream analysis. The output from step 406 is generated and stored in either the database or the output is generated based on a request from the API gateway 318 and the output is returned as a web response.

At step 408, various insights such as descriptive insights, diagnostic insights, predictive or ML-based insights, and the like are generated from the AI-based insight and outcome generation 316 based on data collected, analyzed, and stored in real-time. The data here is the objects 334, the actor 328, the action 330, and the context 332 after performing step 406. The descriptive insights are generated by user activity and sessions, user action summary, user behavior flow, client activities and sessions, touch point analysis, exceptions that occurred by the client, the user, and the like, application key performance indicators, and usage anomalies. The ML-based insights are generated based on ML-based issue severity detection 356, ML-based anomaly detection 358, and ML-based next best action detection 160.

At step 410, the real-time insights 352 are fetched 362, historic insights 364 are fetched, predictions 366 are fetched and these predictions 366 are pushed 368. The real-time insights 352 generated from the event analysis platform 300 are available in both push and pull formats, where delivery layers of the system may publish automatically generated insights such as issue severity to any subscribing systems. Examples of real-time insights 352 are exceptions occurring in the event analysis platform 300, transactions, activity on websites and applications, social media posts, and the like. The aforementioned examples are also stored and available later for historic analysis of the historic insights 364.

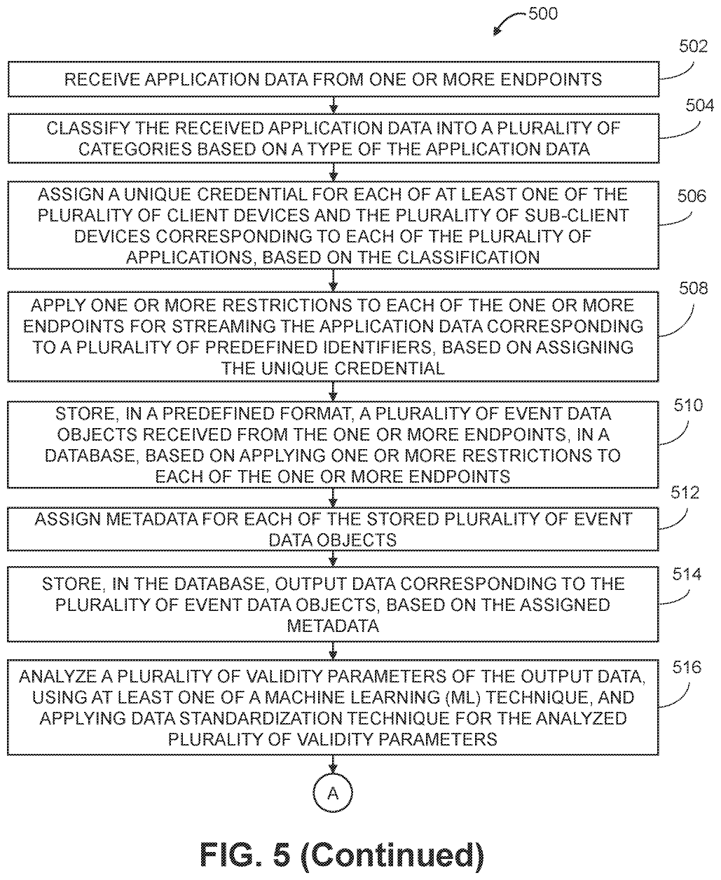

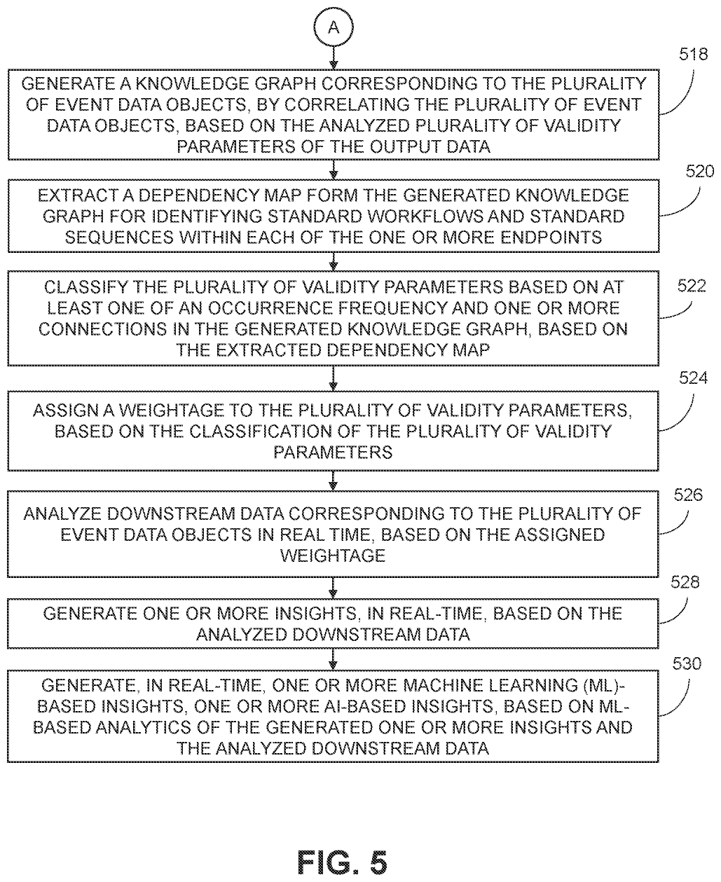

FIG. 5 illustrates a flow chart depicting a method 500 of analyzing event data objects in real-time in a computing environment, in accordance with the embodiment of the present disclosure.

At block 502, the method 500 may include receiving, by one or more hardware processors 110, application data from one or more endpoints. The one or more endpoints include, but are not limited to, a plurality of applications, a plurality of client devices, a plurality of sub-client devices, and the like.

At block 504, the method 500 may include classifying, by the one or more hardware processors 110, the received application data into a plurality of categories based on a type of the application data.

At block 506, the method 500 may include assigning, by the one or more hardware processors 110, a unique credential for each of at least one of the plurality of client devices and the plurality of sub-client devices corresponding to each of the plurality of applications, based on the classification.

At block 508, the method 500 may include applying, by the one or more hardware processors 110, one or more restrictions to each of the one or more endpoints for streaming the application data corresponding to a plurality of predefined identifiers, based on assigning the unique credential.

At block 510, the method 500 may include storing, by the one or more hardware processors 110, in a predefined format, a plurality of event data objects received from the one or more endpoints, in the database 104, based on applying one or more restrictions to each of the one or more endpoints.

At block 512, the method 500 may include assigning, by the one or more hardware processors 110, metadata for each of the stored plurality of event data objects.

At block 514, the method 500 may include storing, by the one or more hardware processors 110, in the database 104, output data corresponding to the plurality of event data objects, based on the assigned metadata. The database 104 may be a part of at least one of a multi-tenant data storage, multi-tenant data analytics, and artificial intelligence (AI)-based insights and outcome generation.

At block 516, the method 500 may include analyzing, by the one or more hardware processors 110, a plurality of validity parameters of the output data, using at least one of a machine learning (ML) technique, and applying data standardization technique for the analyzed plurality of validity parameters.

At block 518, the method 500 may include generating, by the one or more hardware processors 110, a knowledge graph corresponding to the plurality of event data objects, by correlating the plurality of event data objects, based on the analyzed plurality of validity parameters of the output data.

At block 520, the method 500 may include extracting, by the one or more hardware processors 110, a dependency map forms the generated knowledge graph for identifying standard workflows and standard sequences within each of the one or more endpoints.

At block 522, the method 500 may include classifying, by the one or more hardware processors 110, the plurality of validity parameters based on at least one of occurrence frequency and one or more connections in the generated knowledge graph, based on the extracted dependency map.

At block 524, the method 500 may include assigning, by the one or more hardware processors 110, a weightage to the plurality of validity parameters, based on the classification of the plurality of validity parameters.

At block 526, the method 500 may include analyzing, by the one or more hardware processors 110, downstream data corresponding to the plurality of event data objects in real time, based on the assigned weightage.

At block 528, the method 500 may include generating, by the one or more hardware processors 110, one or more insights, in real-time, based on the analyzed downstream data.

At block 530, the method 500 may include generating, by the one or more hardware processors 110, in real-time, one or more machine learning (ML)-based insights, one or more AI-based insights, based on ML-based analytics of the generated one or more insights and the analyzed downstream data. The one or more machine learning (ML)-based insights generated in real-time includes, but are not limited to, exceptions occurring during event analysis, transactions, activities on websites, applications, social media posts, and the like.

The method 500 may be implemented in any suitable hardware, software, firmware, or combination thereof. The order in which the method 500 is described is not intended to be construed as a limitation, and any number of the described method blocks may be combined or otherwise performed in any order to implement the method 500 or an alternate method. Additionally, individual blocks may be deleted from the method 500 without departing from the spirit and scope of the present disclosure described herein. Furthermore, the method 500 may be implemented in any suitable hardware, software, firmware, or a combination thereof, that exists in the related art or that is later developed. The method 500 describes, without limitation, the implementation of the system 102. A person of skill in the art will understand that method 500 may be modified appropriately for implementation in various manners without departing from the scope and spirit of the disclosure.

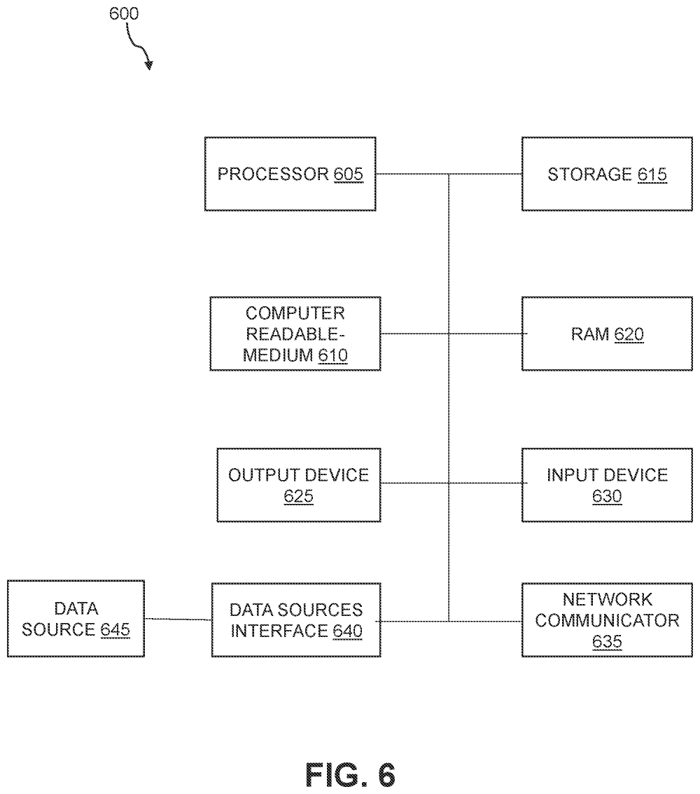

FIG. 6 illustrates an exemplary block diagram representation of a hardware platform 600 for implementation of the disclosed system 102, according to an example embodiment of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 600. As illustrated, the hardware platform 600 may include additional components not shown, and some of the components described may be removed and/or modified. For example, a computer system with multiple GPUs may be located on external-cloud platforms including Amazon Web Services, internal corporate cloud computing clusters, or organizational computing resources.

The hardware platform 600 may be a computer system such as the system 102 that may be used with the embodiments described herein. The computer system may represent a computational platform that includes components that may be in a server or another computer system. The computer system may be executed by the processor 605 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 605 that executes software instructions or code stored on a non-transitory computer-readable storage medium 610 to perform methods of the present disclosure. The software code includes, for example, instructions to gather data and analyze the data. For example, the plurality of modules 114 includes an interaction model generation module 206, an Artificial Superintelligence (ASI) interface generation module 208, a pattern and issue identification module 210, a machine learning module 212, and an ASI interface optimizer module 214.

The instructions on the computer-readable storage medium 610 are read and stored the instructions in storage 615 or random-access memory (RAM). The storage 615 may provide a space for keeping static data where at least some instructions could be stored for later execution. The stored instructions may be further compiled to generate other representations of the instructions and dynamically stored in the RAM such as RAM 620. The processor 605 may read instructions from the RAM 620 and perform actions as instructed.

The computer system may further include the output device 625 to provide at least some of the results of the execution as output including, but not limited to, visual information to users, such as external agents. The output device 625 may include a display on computing devices and virtual reality glasses. For example, the display may be a mobile phone screen or a laptop screen. GUIs and/or text may be presented as an output on the display screen. The computer system may further include an input device 630 to provide a user or another device with mechanisms for entering data and/or otherwise interacting with the computer system. The input device 630 may include, for example, a keyboard, a keypad, a mouse, or a touchscreen. Each of these output devices 625 and input device 630 may be joined by one or more additional peripherals. For example, the output device 625 may be used to display the results such as bot responses by the executable chatbot.

A network communicator 635 may be provided to connect the computer system to a network and in turn to other devices connected to the network including other clients, servers, data stores, and interfaces, for example. A network communicator 635 may include, for example, a network adapter such as a LAN adapter or a wireless adapter. The computer system may include a data sources interface 640 to access the data source 645. The data source 645 may be an information resource. As an example, a database of exceptions and rules may be provided as the data source 645. Moreover, knowledge repositories and curated data may be other examples of the data source 645.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A system for analyzing event data objects in real-time in a computing environment, the system comprising:
one or more hardware processors;
a memory coupled to the one or more hardware processor, wherein the memory comprises a plurality of modules in form of programmable instructions executable by the one or more hardware processors, wherein the plurality of modules comprises:
a data receiving module configured to receive application data from one or more endpoints, wherein the one or more endpoints comprise at least one of a plurality of applications, a plurality of client devices, and a plurality of sub-client devices;
a data classifying module configured to classify the received application data into a plurality of categories based on a type of the application data;
a credential assigning module configured to assign a unique credential for each of at least one of the plurality of client devices and the plurality of sub-client devices corresponding to each of the plurality of applications, based on the classification;
a restriction applying module configured to apply one or more restrictions to each of the one or more endpoints for streaming the application data corresponding to a plurality of predefined identifiers, based on assigning the unique credential;
an object storing module configured to store, in a predefined format, a plurality of event data objects received from the one or more endpoints, in a database, based on applying one or more restrictions to each of the one or more endpoints;
a metadata assigning module configured to assign metadata for each of the stored plurality of event data objects;
an output data storing module configured to store, in the database, output data corresponding to the plurality of event data objects, based on the assigned metadata, wherein the database is a part of at least one of a multi-tenant data storage, multi-tenant data analytics, and artificial intelligence (AI)-based insights and outcome generation;
a parameter analyzing module configured to analyze a plurality of validity parameters of the output data, using at least one of a machine learning (ML) technique, and applying data standardization technique for the analyzed plurality of validity parameters;
a graph generating module configured to generate a knowledge graph corresponding to the plurality of event data objects, by correlating the plurality of event data objects, based on the analyzed plurality of validity parameters of the output data;
a graph extracting module configured to extract a dependency map form the generated knowledge graph for identifying standard workflows and standard sequences within each of the one or more endpoints;
a parameter classifying module configured to classify the plurality of validity parameters based on at least one of an occurrence frequency and one or more connections in the generated knowledge graph, based on the extracted dependency map;
a weightage assigning module configured to assign a weightage to the plurality of validity parameters, based on the classification of the plurality of validity parameters;
a downstream data analyzing module configured to analyze downstream data corresponding to the plurality of event data objects in real time, based on the assigned weightage;
an insight generating module configured to generate one or more insights, in real-time, based on the analyzed downstream data; and
a ML-based insights generating module configured to generate, in real-time, one or more machine learning (ML)-based insights, one or more AI-based insights, based on ML-based analytics of the generated one or more insights and the analyzed downstream data, wherein the one or more machine learning (ML)-based insights generated in real-time comprises at least one of exceptions occurring during event analysis, transactions, activities on websites, applications, and social media posts.

2. The system of claim 1, wherein the plurality of modules further comprises:
an insights retrieving module configured to retrieve at least one of real-time insights, historic insights, and predictions from the analyzed plurality of validity parameters of the output data corresponding to the event data objects;
an issue severity determining module configure to determine issue severity using the retrieved at least one of the real-time insights, the historic insights, and the predictions; and
a data outputting module configured to output the retrieved predictions, and the real-time insights to the one or more endpoints in a push-pull format, based on the determined issue severity, and an insights subscription of the one or more endpoints.

3. The system of claim 1, wherein the application data comprises at least one of software application data, web application data, mobile application data, and Internet of Things (IoT) sensor-enabled devices data, and wherein the application data is received based on streaming by client devices using a plurality of coding languages and a message broker technique.

4. The system of claim 1, wherein the plurality of predefined identifiers comprises at least one of predefined internet protocol (IP) addresses, predefined hostnames, and predefined topics of the application data.

5. The system of claim 1, wherein the predefined format comprises at least one of an actor, an action, a context, and objects.

6. The system of claim 1, wherein the metadata comprises at least one of a timestamp, a geolocation, and a device information.

7. The system of claim 1, wherein the plurality of validity parameters comprises at least one of a consistency, errors, and a format of an action, an object, a context, and an actor.

8. The system of claim 1, wherein the plurality of event data objects is correlated based on the metadata and the one or more endpoints to identify relationships between the one or more endpoints.

9. The system of claim 1, wherein the one or more insights comprises at least on one of descriptive insights, diagnostic insights, and predictive insights.

10. The system of claim 1, wherein the ML-based insights comprise at least one of a ML-based issue severity detection, a ML-based anomaly detection, and a ML-based next best action detection.

11. A method for analyzing event data objects in real-time in a computing environment, the method comprising:
receiving, by one or more hardware processors, application data from one or more endpoints, wherein the one or more endpoints comprise at least one of a plurality of applications, a plurality of client devices, and a plurality of sub-client devices;
classifying, by the one or more hardware processors, the received application data into a plurality of categories based on a type of the application data;
assigning, by the one or more hardware processors, a unique credential for each of at least one of the plurality of client devices and the plurality of sub-client devices corresponding to each of the plurality of applications, based on the classification;
applying, by the one or more hardware processors, one or more restrictions to each of the one or more endpoints for streaming the application data corresponding to a plurality of predefined identifiers, based on assigning the unique credential;
storing, by the one or more hardware processors, in a predefined format, a plurality of event data objects received from the one or more endpoints, in a database, based on applying one or more restrictions to each of the one or more endpoints;
assigning, by the one or more hardware processors, metadata for each of the stored plurality of event data objects;
storing, by the one or more hardware processors, in the database, output data corresponding to the plurality of event data objects, based on the assigned metadata, wherein the database is a part of at least one of a multi-tenant data storage, multi-tenant data analytics, and artificial intelligence (AI)-based insights and outcome generation;
analyzing, by the one or more hardware processors, a plurality of validity parameters of the output data, using at least one of a machine learning (ML) technique, and applying data standardization technique for the analyzed plurality of validity parameters;
generating, by the one or more hardware processors, a knowledge graph corresponding to the plurality of event data objects, by correlating the plurality of event data objects, based on the analyzed plurality of validity parameters of the output data;
extracting, by the one or more hardware processors, a dependency map forms the generated knowledge graph for identifying standard workflows and standard sequences within each of the one or more endpoints;
classifying, by the one or more hardware processors, the plurality of validity parameters based on at least one of an occurrence frequency and one or more connections in the generated knowledge graph, based on the extracted dependency map;
assigning, by the one or more hardware processors, a weightage to the plurality of validity parameters, based on the classification of the plurality of validity parameters;
analyzing, by the one or more hardware processors, downstream data corresponding to the plurality of event data objects in real time, based on the assigned weightage;
generating, by the one or more hardware processors, one or more insights, in real-time, based on the analyzed downstream data; and
generating, by the one or more hardware processors, in real-time, one or more machine learning (ML)-based insights, one or more AI-based insights, based on ML-based analytics of the generated one or more insights and the analyzed downstream data, wherein the one or more machine learning (ML)-based insights generated in real-time comprises at least one of exceptions occurring during event analysis, transactions, activities on websites, applications, and social media posts.

12. The method of claim 11 further comprising:
retrieving, by the one or more hardware processors, at least one of real-time insights, historic insights, and predictions from the analyzed plurality of validity parameters of the output data corresponding to the event data objects;
determining, by the one or more hardware processors, issue severity using the retrieved at least one of the real-time insights, the historic insights, and the predictions; and
outputting, by the one or more hardware processors, the retrieved predictions, and the real-time insights to the one or more endpoints in a push-pull format, based on the determined issue severity, and an insights subscription of the one or more endpoints.

13. The method of claim 11, wherein the application data comprises at least one of software application data, web application data, mobile application data, and Internet of Things (IoT) sensor-enabled devices data, and wherein the application data is received based on streaming by client devices using a plurality of coding languages and a message broker technique.

14. The method of claim 11, wherein the plurality of predefined identifiers comprises at least one of predefined internet protocol (IP) addresses, predefined hostnames, and predefined topics of the application data.

15. The method of claim 11, wherein the predefined format comprises at least one of an actor, an action, a context, and objects.

16. The method of claim 11, wherein the metadata comprises at least one of a timestamp, a geolocation, and a device information.

17. The method of claim 11, wherein the plurality of validity parameters comprises at least one of a consistency, errors, and a format of an action, an object, a context, and an actor.

18. The method of claim 11, wherein the plurality of event data objects is correlated based on the metadata and the one or more endpoints to identify relationships between the one or more endpoints.

19. The method of claim 11, wherein the one or more insights comprises at least on one of descriptive insights, diagnostic insights, and predictive insights, and wherein the ML-based insights comprise at least one of a ML-based issue severity detection, a ML-based anomaly detection, and a ML-based next best action detection.

20. A non-transitory computer-readable storage medium having programmable instructions stored therein, that when executed by one or more hardware processors, cause the one or more hardware processors to:
receive application data from one or more endpoints, wherein the one or more endpoints comprise at least one of a plurality of applications, a plurality of client devices, and a plurality of sub-client devices;
classify the received application data into a plurality of categories based on a type of the application data;
assign a unique credential for each of at least one of the plurality of client devices and the plurality of sub-client devices corresponding to each of the plurality of applications, based on the classification;
apply one or more restrictions to each of the one or more endpoints for streaming the application data corresponding to a plurality of predefined identifiers, based on assigning the unique credential;
store, in a predefined format, a plurality of event data objects received from the one or more endpoints, in a database, based on applying one or more restrictions to each of the one or more endpoints;
assign metadata for each of the stored plurality of event data objects;
store, in the database, output data corresponding to the plurality of event data objects, based on the assigned metadata, wherein the database is a part of at least one of a multi-tenant data storage, multi-tenant data analytics, and artificial intelligence (AI)-based insights and outcome generation;
analyze a plurality of validity parameters of the output data, using at least one of a machine learning (ML) technique, and applying data standardization technique for the analyzed plurality of validity parameters;
generate a knowledge graph corresponding to the plurality of event data objects, by correlating the plurality of event data objects, based on the analyzed plurality of validity parameters of the output data;
extract a dependency map form the generated knowledge graph for identifying standard workflows and standard sequences within each of the one or more endpoints;
classify the plurality of validity parameters based on at least one of an occurrence frequency and one or more connections in the generated knowledge graph, based on the extracted dependency map;
assign a weightage to the plurality of validity parameters, based on the classification of the plurality of validity parameters;
analyze downstream data corresponding to the plurality of event data objects in real time, based on the assigned weightage;
generate one or more insights, in real-time, based on the analyzed downstream data; and
generate, in real-time, one or more machine learning (ML)-based insights, one or more AI-based insights, based on ML-based analytics of the generated one or more insights and the analyzed downstream data, wherein the one or more machine learning (ML)-based insights generated in real-time comprises at least one of exceptions occurring during event analysis, transactions, activities on websites, applications, and social media posts.
